(19) United States
(12) Patent Application Publication
(10) Pub. No.: US 2024/0198266 A1
(43) Pub. Date: Jun. 20, 2024

(54) SPACER FOR FILTER

(71) Applicant: Michael Jablonski, Mülheim a. d. Ruhr (DE)

(72) Inventor: Michael Jablonski, Mülheim a. d. Ruhr (DE)

(21) Appl. No.: 18/565,308

(22) PCT Filed: Mar. 28, 2022
(86) PCT No.: PCT/DE2022/100235

§ 371 Date: Nov. 29, 2023

(30) Foreign Application Priority Data
Jul. 10, 2021 (DE) 10 2021 114 983.5

(51) Int. Cl. B01D 46/00; B01D 46/121

(52) U.S. Cl. CPC B01D 46/0005; B01D 46/0001; B01D 46/0013; B01D 46/121; B01D 2265/06

(57) ABSTRACT

A filter module 1 is used for separating in particular sticky and dry paint and/or adhesive overspray, sanding dust, etc., with a filter setting in a filter housing 2 in the form of an insert 8 formed from a plurality of sections 10-13 for receiving a filter medium 14. Pivotably configured spacer plates 3-7 are integrated into the insert sections 10-13, which are positioned at least approximately at right angles to the plane of the insert section 10-13 when in an outwardly pivoted position.

The invention relates to a filter module for separating, in particular, sticky and dry paint and/or adhesive overspray, sanding dust, etc., with a filter setting in a filter housing in the form of an insert formed from a plurality of sections for receiving a filter medium.

Such separator filters are well known, for example from U.S. Pat. No. 9,555,358. They comprise an outer packaging configured as a filter housing within which a filter module with plate-like inserts arranged one behind the other is positioned. Inasmuch as these filters are exposed to sticky and otherwise problematic substances, it is very useful to provide spacers between the insert sections that make up the filter module in the implementation of a filter setting. This is a spacer for which the perforated lids of the outer packaging are used. This solution has, however, proven to be unsatisfactory in view of the fact that the dimensions of this filter housing cannot be reduced sufficiently for transportation purposes, which leads to considerable additional costs.

The present invention therefore sets itself the task of creating a filter module for separating, in particular, sticky and dry paint and/or adhesive overspray as well as sanding dusts from the filter setting, the dimensions of which can be reduced for transportation purposes.

This is primarily achieved by integrating pivotably configured spacer plates into the insert sections, which are positioned at least approximately at right angles to the plane of the insert section when in an outwardly pivoted position, thereby significantly increasing the stability of the insert when installed while at the same time reducing the space required during transport.

One embodiment of the invention provides that spacer plates are pivotably integrated into the insert sections, which spacer plates can be adjusted between an inwardly pivoted position flush with the insert section and an outwardly pivoted position in which the spacer plate is pivoted out at least approximately at right angles to the plane of the insert section.

The relevant advantage of such a filter module made of corrugated cardboard or plastic lies in the assignment of the spacer plates to the insert sections. Inasmuch as the spacer plate and insert are manufactured in one piece, it is comparatively very easy to move the spacer plate into its outwardly pivoted position, in which the corresponding distance between adjacent insert sections is reliably ensured. The two relevant positions for the spacer plates are the inwardly pivoted and outwardly pivoted positions, between which the spacer plates can be adjusted. In the case of the inwardly pivoted spacer plate, the spacer plate is integrated to a certain extent into the same, without taking up any space whatsoever, whereas in the case of the outwardly pivoted spacer plate, the spacer plate provides maximum and safe, permanent spacing between neighboring insert sections or to the filter housing.

It is advisable that a detachable connection in the form of the spacer plates and accommodations for the spacer plates on these opposite insert sections is provided between adjacent sections of the insert in the installed state, which is to say that the spacer plate is pivoted from the inwardly pivoted to the outwardly pivoted position in order to then achieve a detachable connection between the spacer plate and the accommodation for spacer plate on the opposite insert section.

According to a comparatively simple configuration, the spacer plate comprises a tab on the end face as a corresponding fastening means to the neighboring insert section. This means that when the modules according to the invention are installed, a connection is established between the tabs on the one hand and the neighboring insert sections on the other.

Formulated in a concrete manner, the filter plate comprises a slot that is correspondingly arranged and configured in relation to the opposite spacer plate.

A preferred embodiment refers to the fact that two spacer plates arranged next to each other are provided between the insert sections and the housing wall, which additionally stabilizes the corresponding connection between the two spacer plates.

It is also conceivable to have configurations for such a filter in which spacer plates arranged next to each other are keyed together, for which, thanks to their design, the spacer plates according to the invention are suitable. The arrangement of slots makes it possible to realize an easy-to-produce and secure keyed connection.

It is to be considered expedient if the filter plates and spacer plates are manufactured in one piece. As already mentioned, the spacer plates are pivoted out of the filter plates to a certain extent. It therefore makes sense to provide the die-cuttings in such a way that the spacer plates can be pivoted about a longitudinal axis.

For improved handling of the spacer plate, particularly when pivoting inward and outward, the invention provides for the spacer plate to taper towards its inner side. This allows the operator to handle the spacer plate much better in terms of clearance, even when it is installed.

One such insert forms the contours of a letter W and can therefore also be referred to as a zigzag insert. In this sense, the proposal is understood to mean that four or six filter plates are configured as pivotable four- or six-fold plates. These are configured to fill the space in the housing while maintaining the spacing required for the filter setting to function.

It has already been mentioned that the filter setting is formed by the inserts arranged at a distance. An advantageous arrangement is one in which neighboring insert sections are arranged at an acute angle to each other, leading to the zigzag pattern. This can be accomplished particularly well with the spacer plates according to the invention, inasmuch as these spacer plates are already prefabricated for the specific application, which is to say, the spacer plate specifies the angles—or alternatively vice versa.

In addition, at least one non-woven is provided as a seal between the filter module and the outer packaging. For this purpose, the non-woven filter is placed on the bottom of the outer packaging and after inserting the filter module and before closing the outer packaging, a second non-woven filter is placed on the insert.

The fact that an insert section is equipped with a plurality of spacer plates of different dimensions improves the application possibilities even more, inasmuch as an insert including a spacer plate can be optimally selected and adapted to the circumstances.

The invention moreover relates to a method for installation of a filter module for separating, in particular, sticky and dry paint and/or adhesive overspray, sanding dust, etc., with a filter setting in a filter housing in the form of an insert formed from a plurality of sections for accommodation of a slit paper scrim serving as a filter medium.

The task is now solved according to the invention in that the paper scrims are stretched in the longitudinal direction before installation in the filter module. Depending on the circumstances, stretching can also take place in the actual transverse direction.

The rolls formed by the paper filter scrim are wound up unstretched after their manufacture, which is to say they are supplied in slit, unstretched rolls in various cut patterns. In comparison to a finished, stretched roll, these have the advantage of a significantly reduced freight volume thanks to the paper filter scrims, consisting preferably of eight layers (three coarse, two medium-coarse, and three fine layers). The paper is therefore supplied in slit but still unstretched rolls.

Surprisingly, experiments have shown that targeted expansion of the scrim is possible to a considerable extent. If the stretched paper layer is allowed to be stress-relieved after stretching, the scrim tends to reduce back to its original length. With regard to the width of the scrim, which reduces naturally during stretching, here too the scrim tends to return to its original dimensions. Tests have shown that the paper scrim is stretched by around 25% to 125% in the longitudinal direction, preferably by around 80%. In the transverse direction, a compression of around 100% to 150%, preferably around 120%, can be achieved as a result of stretching in the longitudinal or working direction.

Inasmuch as the stretched/overstretched paper is configured as a single, double or multi-layer web and is placed in the insert, the predetermined inner width of the insert prevents the natural contraction of the actually overstretched paper layers without the need to fasten the individual or plurality of paper layers or the entire filter layer, either to the insert or to the second nonwoven filter behind it. Advantageously, there is also no need for the securing of the individual paper layers one to another, inasmuch as the paper scrim are stress-relieved after stretching, wherein the paper scrim sits in a fixed manner in the transverse direction in the filter housing/outer packaging, creating a clutching effect, and this because the width of the insert restricts the natural stress-relief of the paper scrim.

The invention is, in particular, characterized in that a filter module made of corrugated cardboard and/or plastic is created with a filter setting in the form of a plurality of insert sections arranged spaced apart one behind the other, which filter module is particularly suitable to separate sticky or dry paint or adhesive overspray, as well as sanding dust, with minimum space requirements during transport. It is advantageous if the inserts are in the form of cage-like sections filled with a filter medium. The filter medium consists of one, two or a plurality of identical or different filter mats, for example made of paper scrims or non-woven filters made of polyester or glass fiber or the like.

Integrated spacer plates, which, when not in use, for example, during transportation, are flush with the wall of the filter plate or are located between the two insertion positions, are conceivably very easily folded out of the filter plate for use. The spacer plates are then fastened or alternatively keyed to the neighboring insert sections.

Due to the manufacturing constraints, such an insert made of corrugated cardboard or plastic consists of two parts. The continuous filter material thereby connects the two insert sections. In so doing, at least one of the mat-like filter media that can be placed on top of each other must be in one continuous piece. Fractioned paper scrim filter mats can be used, which previously needed to be laboriously sewn together. This represents a work step that can be omitted in future. The aforementioned filter material, which overlaps at both ends, is absolutely essential because it does not need to be fixed to the insert and the zigzag folding of the insert causes it to compress due to overstretching, thereby shortening the entire length of the mat. In addition, when the entire folded insert is inserted into the outer packaging/filter housing, the overlaps serve as seals in the front two corners of the outer packaging/filter housing. With these inserts, only two insert sections are ever connected to each other and the continuity of the entire insert is created via the front/rear offset. The breaking open of the reversible necks, which are bent on the back, leads to overstretching of the material and thus to simultaneous compression of the entire filter.

The paper scrims are delivered in a slit and pre-stretched state, whereupon an expansion is carried out on site, which is to say, as part of the assembly of the filter, which causes the material to compress. If it is then allowed to be stress-relieved, it tends to expand back to its original dimensions. When the stretched/overstretched paper is placed into the insert, the contour of the insert prevents the previously overstretched paper layers from naturally contracting back.

Further details and advantages of the subject matter of the invention can be seen from the following description of the associated drawing, in which a preferred embodiment example is shown with the necessary details and individual parts. Wherein:

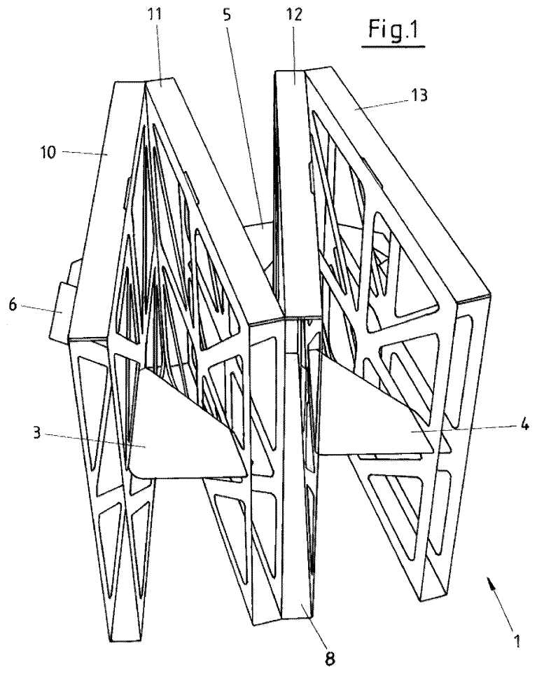

FIG. 1 shows a filter module in perspective view

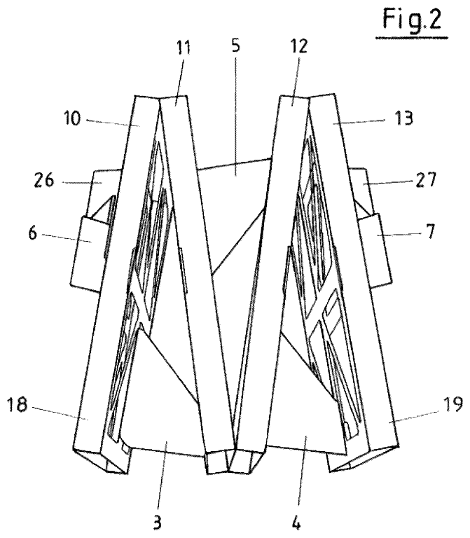

FIG. 2 shows a top view of the module according to FIG. 1

FIG. 3 shows a rear view of a module with additional spacer plates

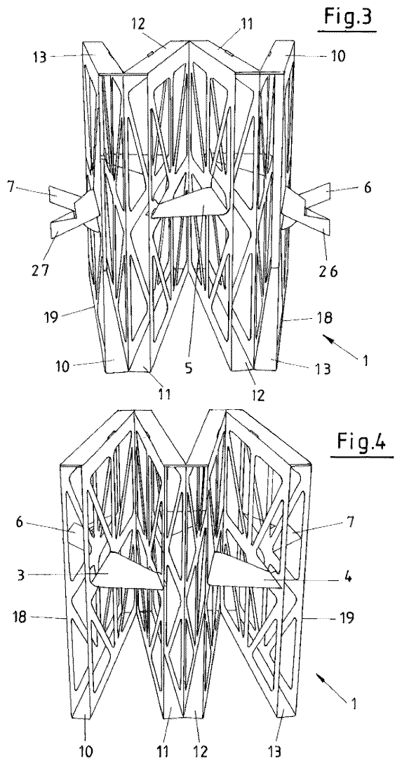

FIG. 4 shows a front view of the filter module according to FIG. 3

FIG. 5 shows a module prior to assembly

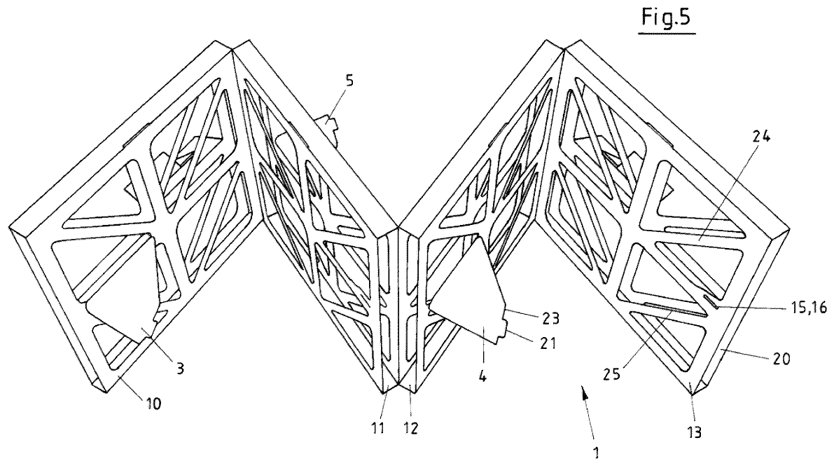

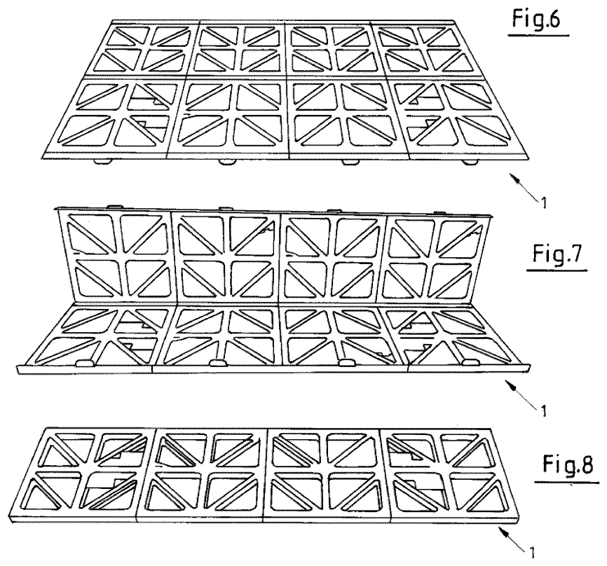

FIG. 6 through FIG. 8 show a filter module in various assembly states

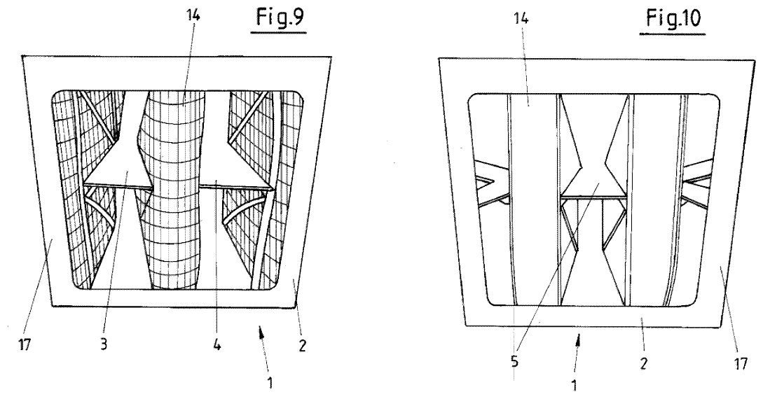

FIG. 9 shows a front view of a filter housing with filter medium, and

FIG. 10 shows a rear view of a filter housing with filter medium.

FIG. 1 shows a filter module 1 with an insert 8 in the form of four insert sections 10-13. These sections enclose in a cage-like manner the filter medium, which is in the form of filter mats, which medium is not shown here. The pivotably connected insert sections 10-13 arranged one behind the other at an acute angle and in the shape of a W, form the filter setting. Spacer plates between the insert sections 10 and 11 or alternatively 12 and 13 are designated by the reference signs 3, 4. The spacer plates 3, 4 are folded out of the plane of the respective insert sections 10 and 12 and latched onto the opposite insert section 11, 13.

In the top view according to FIG. 2, in addition to the spacer plates 3 and 4 between the inserts 10 and 11 or alternatively 12 and 13, the spacer plate 5 can also be seen between the insert sections 11 and 12. The two spacer plates 3 and 4 in turn serve to define the angle between the insert sections 10, 11 or alternatively 12, 13. Spacer plates 6, 26 and 7, 27 are, moreover, located on the outer sides 18, 19 of the insert sections 10 and 13.

A rear view of FIG. 3 shows the filter module 1, formed from the insert sections 10-13 with spacer plates 6, 26, 7, 27 on the outer side 18, 19 of the insert 10, 13. The double spacer plate 6, 26, 7, 27 is created by spacer plates keyed together on the outer side 18, 19.

FIG. 4 shows a front view of the corresponding filter module 1 with the spacer plates 3, 4 between the inserts/filter plates 10, 11 or alternatively 12, 13.

The construction of such a filter module 1 as a module consisting essentially of four insert sections 10-13 is then illustrated in FIG. 5 with the spacer plates 3, 4 pivoted outward from the plane of the inserts 10-13, viewed from left to right. By way of example, reference is made to the tab 21 on the end face 23 of the spacer plate designated 4. This tab corresponds to the accommodation 16, configured as a slot 15, on the inside 20 of the insert section 10 facing the insert section 13. Such a filter module 1 is dimensioned and configured in such a way that a filter mat not shown here can be inserted. To this end, such an insert section 10 comprises a plurality of struts, here by way of example provided with the reference signs 24 and 25, which serve as a kind of cage for the filter mat.

FIG. 6, FIG. 7, and FIG. 8 moreover also show a filter module during assembly. FIG. 6 shows the filter module 1 pivoted completely outwards, FIG. 7 shows the filter module 1 during the pivoting and FIG. 8 shows it pivoted inwards.

Lastly, FIG. 9 and FIG. 10 show a filter housing 2 in the form of an outer packaging with the housing wall 17 for the filter medium 14 in the form of a filter mat. The overlapping ends of the filter material seal the insert above the height of the cardboard filter at the front inner corners of the outer packaging 2, the spacers 3-5 maintain the insert 8 in a stable position in the outer packaging 2 and also ensure that all insert sections are flowed through as a filter surface and thus contribute functionally to separation.

1. A filter module (1) for separating in particular sticky and dry paint and/or adhesive overspray, sanding dust, etc., with a filter setting in a filter housing (2) in the form of an insert (8) formed from a plurality of sections (10-13) for receiving a filter medium (14),
wherein
pivotably configured spacer plates (3-7) are integrated into the insert sections (10-13), which, in an outwardly pivoted position, are positioned at least approximately at right angles to the plane of the insert section (10-13).

2. The filter module according to claim 1,
wherein
the spacer plates (3-7) can be adjusted between an inwardly pivoted position flush with the insert section (10-13) and the outwardly pivoted position.

3. The filter module according to claim 1,
wherein
a detachable connection in the form of the spacer plates (4) and accommodations (16) for the spacer plates (4) is provided between adjacent sections (10-13) of the insert (8) in the installed state.

4. The filter module according to claim 1,
wherein
the spacer plate (3) comprises a tab (21) on the end face.

5. The filter module according to claim 1,
wherein
the insert sections (13) comprise slots (15) which are correspondingly arranged and configured to the opposite spacer plate (4).

6. The filter module according to claim 1,
wherein
two spacer plates (6, 26, 7, 27) arranged next to each other are provided between an insert section (10, 13) and the housing wall (17) of the filter housing (2).

7. The filter module according to claim 6,
wherein
spacer plates (6, 26, 7, 27) arranged next to each other are keyed together.

8. The filter module according to claim 1,
wherein
insert (8) and spacer plates (3-7) are manufactured in one piece.

9. The filter module according to claim 1,
wherein
the spacer plate (3-7) tapers towards its inner side (26).

10. The filter module according to claim 1,
wherein
a non-woven serves as a seal between the filter module (1) and the filter housing (2).

11. The filter module according to claim 1,
wherein
an insert section (10-13) is equipped with a plurality of spacer plates (3-7) of different dimensions and/or positionings.

12. The filter module according to claim 1,
wherein
the paper scrim serving as filter medium comprises single, double or multi-layered webs.

13. A method for installation of a filter module for separating, in particular, sticky and dry paint and/or adhesive overspray, sanding dust, etc., with a filter setting in a filter housing in the form of an insert formed from a plurality of sections for accommodation of a slit paper scrim serving as filter medium,
wherein
the paper scrims are stretched in the longitudinal direction before installation in the filter housing module.

14. The method according to claim 13,
wherein
the paper scrims are stretched by around 25% to 125% in the longitudinal direction.

15. The method according to claim 13,
wherein
the paper scrims are stress-relieved after stretching, wherein the paper scrim sits in a fixed manner in the transverse direction in the filter housing, creating a clutching effect.

16. A filter module manufactured by a method according to claim 13.

17. A filter module manufactured by a method according to claim 14.

18. A filter module manufactured by a method according to claim 15.

19. The method according to claim 14, wherein the paper scrims are stretched by around 80%.
